(19) United States
(12) Patent Application Publication
(10) Pub. No.: US 2026/0194888 A1
(43) Pub. Date: Jul. 9, 2026

(54) END-TO-END CONNECTION IN A DISTRIBUTED MANUFACTURING AUTOMATION SYSTEM

(71) Applicant: BASF SE, Ludwigshafen am Rhein (DE)

(72) Inventors: Ole GUETSCHOW, Schwarzheide (DE); Jan AUGUSTIN, Schwarzheide (DE); Andreas SEIDE, Schwarzheide (DE); Harro BONNOWITZ

(21) Appl. No.: 19/124,078

(22) PCT Filed: Oct. 26, 2023
(86) PCT No.: PCT/EP23/79989

§ 371 Date: Apr. 24, 2025

(30) Foreign Application Priority Data
Oct. 26, 2022 (EP) 22203899.4

(51) Int. Cl. G05B 19/418

(52) U.S. Cl. CPC G05B 19/41855

(57) ABSTRACT

Disclosed herein is a distributed manufacturing automation system including multiple groups of apparatuses, where each group of apparatuses of the groups of apparatuses is configured to perform a respective type of control of a manufacturing process. The distributed manufacturing automation system includes a first apparatus of a specific group of apparatuses of the multiple groups. The first apparatus includes means being configured to use a first network slice for an end-to-end connection with a data network, the first network slice being exclusively assigned to the specific group of apparatuses.

### TECHNICAL FIELD

Various example embodiments relate to automation systems, and more particularly to an apparatus and method for end-to-end connection in a distributed manufacturing automation system.

### BACKGROUND

New generations of radio systems and network architectures are expected to provide higher bitrates and coverage than existing systems. They are also expected to increase network expandability up to hundreds of thousands of connections.

### SUMMARY

Example embodiments provide a distributed manufacturing automation system comprising multiple groups of apparatuses, wherein each group of apparatuses of the groups of apparatuses is configured to perform a respective type of control of a manufacturing process.

The distributed manufacturing automation system comprises a first apparatus of a specific group of apparatuses of the multiple groups. The first apparatus comprises means being configured to use a first network slice for an end-to-end connection with a data network, wherein the first network slice is assigned to the specific group of apparatuses. In an example the first network slice is exclusively assigned to the specific group of apparatuses and in particular to a data_item generated by the first apparatus of that specific group of apparatuses.

The means of the first apparatus of the group of apparatuses be further configured to extract a sub-data item and to use a second network slice and/or a third network slice for the extracted sub-data item. The second network slice and/or the third network slice and any other further network slice, may be different from the first network slice. In an example, the apparatus may comprise an extraction device, wherein the extraction device is configured to extract a sub-data item and to use a second network slice and/or a third network slice different from the first network slice for the extracted data item.

In other words, the first apparatus may generate a data item that comprises at least a first sub-data item and a second sub-data item. One of the sub-data items may be extracted from the data_item and may flexibly be transmitted to another network slice than the other sub-data item.

The sub-data item may be a portion of a data_item generated by the first apparatus. The extracting of a sub-data item may allow for routing a specific portion of a data item generated by the first apparatus to be transmitted to a different network slice then the network slice that is used by the first network apparatus.

Example embodiments provide a method for a distributed manufacturing automation system comprising multiple groups of apparatuses, wherein each group of apparatuses of the groups of apparatuses is configured to perform a respective type of control of a manufacturing process.

The method comprises using by a first apparatus of a specific group of the groups a first network slice for an end-to-end connection with a data network, wherein the first network slice is assigned to the specific group of apparatuses.

The method may further comprises extracting a sub-data item from a data item generated by the first apparatus. The method also comprises using by the first apparatus a second network slice and/or a third network slice for the extracted sub-data item.

The second network slice and/or the third network slice and any other further network slice, may be different from the first network slice. In an example, the apparatus may comprise an extraction device, wherein the extraction device is configured for extracting the sub-data item. The sub-data item may be handled differently than the rest of the data-item. The standard data-item may be routed to the first network slice. The extracted portion of the data-item however, may be routed to another network slice. All sub-data items may be part of an end-to-end connection via the corresponding network slice.

An apparatus for a specific group of apparatuses of a distributed manufacturing automation system may be provided. The apparatus comprises means being configured to use a first network slice for an end-to-end connection with a data network, wherein the first network slice is in an example exclusively assigned to the specific group.

According to an example embodiment, the means of the first apparatus of the group of apparatuses be further configured to determine which of the second network slice and/or the third network slice is appropriate to be used.

In another example embodiment the determining of which of the second network slice and/or the third network slice is appropriate to be used is based on a monitoring operation.

In an example a configuration of the first apparatus may be detected. The configuration of the first apparatus may indicate to route the data type of the sub-data item to a specific network slice. The first apparatus may be adapted in order to store a link and/or relation between a data type of the sub-data item and a corresponding type of a network slice.

In other words, a profile of a sub-data item may be detected. This profile may be linked to a specific characteristic of a network slice. If it is determined that the link between the sub-data item and the characteristic of a network slice does substantially differ, a more appropriate network slice may be determined, and the sub-data item may be routed to this network slice.

In a particular example, the first apparatus and the data_item generated by the first apparatus may be associated with a network slice according to the device type of the first apparatus. The device type may be determined according to an intended use of the first apparatus. For instance, a camera may be allocated to a network slice with a high throughput, e.g. to a field device level of the automation pyramid. The field device level and/or the field device slice may have as a characteristic a high throughput but a low reliability.

However, it may be determined, that this device also generated different data types. E.g. a camera may be used to detect a person and generate an alarm. For such an alarm a high reliability may be useful. The alarm may be processed field device data. The alarm or trigger signal may be a sub-data item from the general data-item generated by the camera. Thus, the alarm sub-data item may be routed to a different network slice, e.g. a network slice with a high reliability as a characteristic.

In a further example embodiment, the determining of which of the second network slice and/or the third network slice is appropriate to be used is based on a monitoring operation.

The first apparatus in one example may monitor different configurations set up by a user and may be adapted to detect patterns of the settings for the sub-data item. In another example the first apparatus may determine the profile of a sub-data item and upon detecting a change and/or a deviation from the profile of the other data-item, the first apparatus may initiate a reconfiguration and again may try to determine a pattern of the configuration. Such a pattern may be used when a new device of the same type may be connected to the distributed manufacturing automation system.

In yet another example the monitoring operation comprises machine learning.

Different profiles of the sub-data item may be differentiated and allocated to different characteristics of the network slices. The characteristics of the network slices may be defined by slice parameter such as quality of service (QOS), reliability, latency, bandwidth etc. The data coming from a group of apparatuses may substantially have the same properties and/or profiles and may also have same or similar requirements for the characteristics of slices.

However, at least one apparatus of the group of apparatuses may generate different data types having different profiles and therefore may be allocated to at least two network slices. This allocation may be made by a scheduling device and/or be manually configured by an operator.

The scheduling device recognises different data transmission properties of different data from one single apparatus of the group of apparatuses and extracts the relevant data to be allocate to a slice with a different characteristic.

Such rescheduling and/or extracting and/or reconfiguration may be detected by the scheduling device. The scheduling device may have machine learning means that may use the detected patterns for data types, profiles of data streams and/or allocations to network slices for configuring a newly added apparatus to the group of apparatuses. The scheduling device may make configuration proposals in order to allocate a data item generated by the newly added apparatus to a corresponding slice. In other words, the scheduling device may make a profiling of a data source in order to dynamically schedule the data stream generated by the apparatus to the appropriate slice.

Example embodiments provide a distributed manufacturing automation system being configured as an automation pyramid. The distributed manufacturing automation system comprises a first apparatus of a specific level of the automation pyramid. The first apparatus comprises at least one processor; and at least one memory storing instructions that, when executed by the at least one processor, cause the apparatus at least to use a first network slice for an end-to-end connection with a data network, wherein the first network slice is exclusively assigned to the specific level of the automation pyramid.

In an example the means of the distributed manufacturing automation system comprises at least one processor; and at least one memory storing instructions that, when executed by the at least one processor, cause the first apparatus the performance of the use of the first network slice.

According to further example embodiments, a method is provided. A distributed manufacturing automation system is provided. The distributed manufacturing automation system is configured as an automation pyramid. The method comprises using by a first apparatus of a specific level of the automation pyramid a first network slice for an end-to-end connection with a data network, wherein the first network slice is exclusively assigned to the specific level of the automation pyramid.

The extraction of the sub-data item may allow for using different levels of the automation pyramid than the level used by the first apparatus.

According to further example embodiments, a computer program product is provided. The computer program product comprises a computer-readable storage medium having computer-readable program code embodied therewith. The computer-readable program code is configured to implement the method of any of the preceding embodiments.

According to further example embodiments, an apparatus for a distributed manufacturing automation system is provided. The distributed manufacturing automation system is configured as an automation pyramid. The apparatus comprising means being configured to use a first network slice for an end-to-end connection with a data network, wherein the first network slice is exclusively assigned to the specific level of the automation pyramid.

The means comprises at least one processor; and at least one memory including computer program code, the at least one memory and the computer program code being configured to, with the at least one processor, cause the apparatus to use a first network slice for an end-to-end connection with a data network, wherein the first network slice is exclusively assigned to the specific level of the automation pyramid.

In other words, the means of the apparatus comprises at least one processor; and at least one memory storing instructions that, when executed by the at least one processor, cause the apparatus the performance of the use of the first network slice.

The computer program product may comprise a computer program. The computer program product may refer to any set of one, or more, storage media (also called “mediums”) collectively included in a set of one, or more, storage devices that collectively include machine readable code corresponding to instructions and/or data for performing computer operations specified in the computer program product claim. A “storage device” may be any tangible device that can retain and store instructions for use by a computer processor.

### BRIEF DESCRIPTION OF THE DRAWINGS

The accompanying figures are included to provide a further understanding of examples, and are incorporated in and constitute part of this specification. In the figures:

FIG. 1 depicts a distributed manufacturing automation system in accordance with an example of the present subject matter;

FIG. 2 depicts a distributed manufacturing automation system in accordance with an example of the present subject matter;

FIG. 3 depicts a distributed manufacturing automation system in accordance with an example of the present subject matter;

FIG. 4 depicts a system for enabling communication of data at a distributed manufacturing automation system according to an example of the present subject matter;

FIG. 5 depicts a system for enabling communication of data at a distributed manufacturing automation system according to an example of the present subject matter;

FIG. 6 depicts a system for enabling communication of data at a distributed manufacturing automation system according to an example of the present subject matter;

FIG. 6a depicts a system for enabling communication of data at a distributed manufacturing automation system with a scheduling device according to an example of the present subject matter FIG. 7 is a flowchart of a method for communication in a distributed manufacturing automation system according to an example of the present subject matter;

FIG. 8 is a flowchart of a method for communication in a distributed manufacturing automation system according to an example of the present subject matter;

FIG. 9 depicts a system for enabling communication of data at a distributed manufacturing automation system according to an example of the present subject matter;

FIG. 10 depicts an automation apparatus in accordance with an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

Embodiments of the present subject matter may be advantageous as they may improve access to radio systems and network architectures in the field of manufacturing automation systems.

Automation, in the context of manufacturing, may refer to the use of devices such as sensors, actuators, robots and computers to automate manufacturing processes. The manufacturing process may, for example, refer to the steps of a method used to prepare a composition. The manufacturing process may involve the use of manufacturing facilities such as equipment, raw materials, machinery, tools, plant etc. The manufacturing process may have one or more properties (herein referred to as manufacturing properties). Examples of manufacturing properties may comprise the temperature, the pressure, the process time, the melting point of a substance, the flexural strength of a steel, the resistance of an electrical conductor etc. The manufacturing process may have one or more parameters (herein referred to as manufacturing parameters) that enable control of the manufacturing process. Examples of manufacturing parameters may comprise mixing rate, temperature etc. Automation, and thus control, of the manufacturing process may be performed by acquiring process data, analysing the process data and automatically adjusting a manufacturing parameter based on the analysis. The process data may comprise values of one or more manufacturing properties of the manufacturing process. Different types of control may be provided depending on the acquired process data and/or type of the analysis and/or type of controlled manufacturing parameters.

For example, one type of control may check property values against thresholds and adapt one or more manufacturing parameters accordingly. Another type of control may perform a more sophisticated (time consuming) analysis of the manufacturing property in order to adjust one or more manufacturing parameters. The different types of control may have different time frames of the control e.g., the control may be real-time or non-real time control.

The control of the manufacturing process may advantageously be performed by a distributed manufacturing automation system. The distributed manufacturing automation system may comprise dispersed manufacturing facilities and various devices which may be spread across multiple systems located in different locations. The distributed manufacturing automation system may comprise multiple groups of apparatuses, wherein each group of apparatuses of the groups of apparatuses is configured to perform a distinct type of control of the manufacturing process.

For example, each type of control of the manufacturing process may have a respective time frame within which the control of the manufacturing process may have to be performed. In other words, each type of control of the manufacturing process has a respective time frame for the control. The distributed manufacturing automation system may be implemented in accordance with a functional model in order to enable the different types of control of the manufacturing process. The functional model may define a function of individual devices, how data is exchanged and formatted within the distributed manufacturing automation system, and how the devices are interconnected within the distributed manufacturing automation system. In one example, the functional model may be the ISA-95 functional model. The ISA-95 functional model may, for example, be a hierarchical pyramidal model or a network-based architecture model.

The distributed manufacturing automation system being configured as an automation pyramid means that the distributed manufacturing automation system is implemented in accordance with a functional model which is a hierarchical pyramidal model. Each group of the multiple groups belongs to a distinct level of the hierarchical pyramidal model. For example, the first level may require a control time frame of milliseconds, the second level may require a control time frame of seconds etc. in other words, each apparatus of group of apparatuses of a certain level may have a specific traffic profile.

For example, the functional model may describe a hierarchical arrangement of devices of the distributed manufacturing automation system according to a field level, control level, supervision level and information level.

The field level and/or field device level may be the lowest level which may include field devices such as sensors and actuators. The field devices may be configured to transfer the process data of the manufacturing process to the next higher level for monitoring and analysis. For example, sensors may convert real time manufacturing properties such as temperature and pressure into sensor data. The sensor data may further be transferred to a controller so as to analyse the real time properties. Actuators may convert electrical signals from controllers into mechanical means to control the manufacturing process.

The control level may consist of various controllers such as Programmable Logic Controllers (PLCs) which may acquire the manufacturing properties from various sensors. The controllers may drive actuators based on the processed sensor data and control technique.

The supervision level may consist of monitoring devices that enable intervening functions, supervising various manufacturing properties, setting production targets, historical archiving, setting machine start and shutdown, etc.

The information level may manage the whole distributed manufacturing automation system. The tasks of this level may include production planning, customer and market analysis, orders and sales etc.

One or more communication networks may be present in all the levels to provide continuous flow of data. The present subject matter may further improve the communication of data in the distributed manufacturing automation system by using wireless connectivity. This may provide flexible and efficient implementation of the distributed manufacturing automation system. The wireless connectivity may enable communication of data between devices of the distributed manufacturing automation system. In case of a hierarchical functional model, the wireless connectivity may enable communication of data between the hierarchical levels. Additionally, or alternatively, the wireless connectivity may enable communication of data between the distributed manufacturing automation system and other external systems.

A communication network, e.g. a data communication network, a wide area network and/or a wireless communication network, may be used in order to link the different parts of the distributed manufacturing automation system over long distance. The communication network may be adapted to maintain and ensure the different requirements of the functional model of the manufacturing automation system over the long range of data communication.

An automation apparatus, a scheduling device and/or a cellular network may be the linking component and/or the interface between the automation and manufacturing domain of an industrial campus over the wide distance of data communication provided by a communication network. The automation apparatus therefore may be adapted to map the requirements of a functional model of the manufacturing automation system to the communication network linking different locations of an industrial production network. In this way supply chains may be linked and the digitalisation of production, e.g. in the chemical industry, may be supported.

For example, a cellular network may be provided. The cellular network may comprise a base station and a core network device. The cellular network may enable high-speed wireless connectivity, wherein the speed of wireless connectivity is higher than a minimum speed that fulfills the ultra reliable low latency communications (URLLC) requirements. The minimum speed may, for example, be 10 GB per second. For example, the cellular network may be a fifth-generation (5G) cellular network. The base station may include a wireless communication station. The base station may, for example, be a gNodeB (gNB). The base station may be installed at a fixed terrestrial location and used to facilitate communication in the cellular network. The base station may serve devices of the distributed manufacturing automation system in a given geographical area. The core network device may be a collection of network hardware, devices, and software that provides fundamental functionalities e.g., of a data plane and control plane. The core network device may implement one or more functionalities of a data plane and control plane. The functionalities may, for example, include at least one of: a user plane function (UPF), Network Exposure Function (NEF), Core Access and Mobility Management Function (AMF), Session Management Function (SMF), Policy Control Function (PCF) and Unified Data Management (UDM). The base station may comprise resources such as processing resources and radio resources. These resources may be referred to as access resources. The core network device may comprise resources such as processing and radio resources which may be referred to as core resources.

Data communication in the distributed manufacturing automation system through the wireless connectivity may need to be secure to prevent attacks, tampering from adversaries and loss of confidentiality of manufacturing processes. For that, the communication between an automation apparatus and a data network may be performed through an end-to-end connection across the wireless network. The automation apparatus may send data through the end-to-end connection to a receiver that is connected to the data network. The end-to-end connection may be a connection between the automation apparatus and the data network. The end-to-end connection may, for example, be an active connection between the automation apparatus and the data network via the cellular network. The data network may be any network of the networks present in the levels of the distributed manufacturing automation system or an external network such as the Internet.

The end-to-end connection may be implemented as a network slice that is exclusively assigned to the group of apparatuses to which the automation apparatus belongs. In case of the hierarchical pyramidal model, the end-to-end connection may be implemented as a network slice that is exclusively assigned to the level of the automation pyramid to which the automation apparatus belongs. The network slice may be a logical network that provides specific network capabilities and network characteristics based on the access resources and core resources.

The network slice may be an independent physical end-to-end network or a logical end-to-end network running on a shared physical infrastructure. The network slice may be a collection of network functions and specific radio access technology (RAT) settings that are combined together for the specific use case associated with the automation apparatus. The network slice may, for example, be a 5G slice.

The network slice may be defined using at least two segments, the first and second segments. The first segment may be an access slice which is assigned specific access resources at the base station and may support different or fixed radio access technologies at the base station. The second segment may be a core network slice which provides one or multiple virtualized network functions. An additional segment may, for example, be a slice pairing function that connects the first and second segments to form an end-to-end network slice. The pairing between the first and second segments may be 1:1 or 1:Multiple, e.g., an access segment may have multiple core network segments built on top.

The present subject matter may advantageously use the network slices for different groups of apparatuses e.g., for different levels of the automation pyramid. For example, a number N of automation apparatuses may be provided, where N is an integer higher than or qual to 1, N≥1. The automation apparatus may be referred to as

$${app}_{i}^{l} ,$$

where index i may be any value between 1 and the number N of apparatuses, and l is an index referring to the group of apparatuses to which the i^{th} automation apparatus

$${app}_{i}^{l}$$

belongs. In the following, the hierarchical pyramidal model may be used as an example implementation so that l is an index referring the level of the automation pyramid to which the i^{th} automation apparatus

$${app}_{i}^{l}$$

belongs and l is any value between 1 and the total number K of levels of the automation levels. Apparatuses of the N automation apparatuses may belong to the same levels or different levels of the automation pyramid. The automation apparatus

$${app}_{i}^{l}$$

may be any device of the distributed manufacturing automation system that contributes to the control of the manufacturing process. The automation apparatus

$${app}_{i}^{l}$$

may, for example, be a sensor, actuator, PLC, computer etc. The automation apparatus

$${app}_{i}^{l}$$

may comprise identification data that enables the automation apparatus

$${app}_{i}^{l}$$

to authenticate with the cellular network and thus communicate through the cellular network. For example, the automation apparatus

$${app}_{i}^{l}$$

may comprise a Subscriber Identity Module (SIM) card, which uniquely identifies the automation apparatus

$${app}_{i}^{l}$$

and establishes the radio parameters needed to communicate with the base station.

The automation apparatus

$${app}_{i}^{l}$$

and the base station may use a time division duplex (TDD) technique for data transmission. The automation apparatus

$${app}_{i}^{l}$$

may be configured to use a network slice NSₗ for an end-to-end connection with a data network DNₗ. The network slice NSₗ is exclusively assigned to the level l of the automation pyramid such that all apparatuses belonging to that level l may communicate through the network slice NSₗ. Data networks to which two different automation apparatuses communicate may or may not be the same e.g., two automation apparatuses may communicate with the same data network or with different data networks.

The network slices may enable protection against external attacks; however, data managed inside a network slice NSₗ may be exposed to applications running in other network slices services, through side channel attacks. To solve this issue, the present subject matter may isolate the network slice NSₗ. The isolation of the network slice NSₗ may be performed by isolating at least one segment of the segments of the network slice NSₗ. The isolation of the first segment of the network slice NSₗ may comprise the exclusive assignment of specific radio resources or processing resources at the base station for the network slice NSₗ. The isolation of the second segment of the network slice NSₗ may comprise isolation of network functions (NFs) so that some NFs may be common to multiple network slices whereas some are customized for specific network slices. Isolating the slice pairing function may, for example, require a 1:1 pairing between the first segment and the second segment.

The present subject matter may further secure data communication through the network slices by controlling the isolation level of each network slice. The isolation level of a network slice NSₗ may indicate the percentage of logical and/or physical isolation of the network slice NSₗ. For example, the isolation level of a network slice may indicate the network slice is fully (100%) or partly (<100%), logically and/or physically, isolated from another network slice. This may enable a strong network slice isolation and connection that may prevent a compromise of the system security. For example, the isolation level may be controlled so that each pair of network slices NSₗ₁ and NSₗ₂ where l1≠l2 may be fully physically separated such that each network slice has a physical network isolation, physical computing resources isolation etc. Alternatively, or additionally, the each pair of network slices NSₗ₁ and NSₗ₂ where l1≠l2 may be fully logically separated using, for example, network function isolation and virtual resources isolation such as virtual machine (VM) isolation.

The communication through the network slices may further be secured by the present subject matter by using at least one of the following: encryption or authentication. For example, the automation apparatus

$${app}_{i}^{l}$$

may encrypt the data to be transmitted. The automation apparatus

$${app}_{i}^{l}$$

may send the encrypted data through the network slice NSₗ to a receiver that is connected to the data network. The receiver may be configured to decrypt the encrypted data. Additionally or alternatively, before data communication can occur authentication data may be communicated between the automation apparatus

$${app}_{i}^{l}$$

and the receiver. The authentication data allows the receiver to authenticate the automation apparatus

$${app}_{i}^{l}$$

before it enables the automation apparatus

$${app}_{i}^{l}$$

to send the data. Using different combinations of authentication and encryption techniques may enable to control the security level of the communication e.g., a high security level may be enabled by using an asymmetric encryption technique and a multi-dimensional authentication technique e.g., using a multi-dimensional password. A lower security level may be enabled by using authentication only. Thus, according to one embodiment, each slice of the network slices is configured according to a specific security level Sₗ defined by at least one of the following: authentication or encryption.

According to one embodiment, each network slice NSₗ of the network slices is configured according to a respective predefined latency Lₗ and throughput Tₗ. For example, the latency in the network slice NSₗ may be required to be smaller than the latency Lₗ and the maximum throughput allowed in the network slice NSₗ may be throughput TI. This may enable a flexible and focused control of the data communication on the slice level.

According to one embodiment, each network slice of the network slices is configured according to a distinct value of a performance parameter. The performance parameter comprises at least one of the following: availability, area of service, maximum packet size, maximum number of apparatuses that can use the network slice simultaneously, or radio spectrum in which the network slice is supported.

The availability may, for example, be a percentage value. The availability may, for example, be the amount of time the system is expected or desired to deliver the end-to-end communication service by the amount of time the end-to-end communication service is delivered. The availability may be an important indicator of the overall system reliability. This embodiment may enable to control the availability of the network slice depending on the level of the automation pyramid to which it is assigned. For example, the smaller the level l, the higher the availability of the network slice NSₗ. For example, a level of the automation pyramid that requires a very small time frame for controlling the manufacturing process may be provided with a higher availability value compared to other levels. Providing the different network slices NS₁, . . . , NS_{K} with different availabilities may thus be advantageous.

The area of service may specify the area where the apparatuses may access a particular network slice. For example, the area of service of a network slice may be an industrial floor where specific automation apparatuses are located. Providing the network slices with different areas of services may further secure data communication in accordance with the present subject matter because the number and type of apparatuses that use the network slice may be controlled e.g., limited to a maximum number.

Controlling the maximum packet size per network slice may enable to achieve the required latencies. For example, the radio performances may be improved by reducing the packet size so that a high number of small packets are transmitted by a high number of devices.

Controlling the radio spectrum in which the network slice is supported may be advantageous because some automation apparatuses may only use certain frequency bands.

According to one embodiment, the data network DN, to which the automation apparatus

$${app}_{i}^{l}$$

communicates through the network slice NSₗ is a network at the specific level l or at another level of the automation pyramid different from the specific level l. For example, an automation apparatus

$${app}_{i}^{2}$$

of the second level may communicate though the slice network NS₂ with a data network of that level 2 or another level e.g., level 3.

According to one embodiment, the data network to which the automation apparatus

$${app}_{i}^{l}$$

communicates through the network slice NSₗ may be an information technology (IT) network or an operation technology (OT) network of the distributed manufacturing automation system. The IT network may, for example, be a network of the fourth level of the automation pyramid. The OT network may, for example, be a network of the third level of the automation pyramid.

According to one embodiment, the distributed manufacturing automation system further comprises the cellular network, wherein the network slice NSₗ comprises a user plane function (UPFₗ) network element. The total number K of UPFs may be different instances of the UPF element of the core network device. The automation apparatus

$${app}_{i}^{l}$$

may set up a PDU session via gNB to the UPFₗ for establishing the end-to-end connection according to the network slice NSₗ. The UPFₗ may serve as an external point of interconnect to a Data Network DNₗ for the PDU sessions. The UPFₗ may be responsible for the UP functionalities, which may include packet routing and forwarding, UP part of policy rules enforcement, and in general quality of service (QoS) enforcement for the user plane.

According to one embodiment, the network slice, e.g. the first network slice, is placed in a demilitarized zone, DMZ. For example, placing the network slice in a DMZ may comprise providing the network slice with a DMZ network. The DMZ network may comprise systems enabling network administrators to manage external traffic e.g., internet traffic. The DMZ Network may enable extra protection in detecting and mitigating security breaches before they reach the network slice.

In other words, between each level of the automation pyramid an own firewall may be used substantially only allowing for a communication between the two levels, e.g. be-tween field device level and automation level, but not between field device level and monitoring level. If however, the DMZ, in particular a firewall, is placed in the first cellular network, it may be possible that the first cellular network is able to communicate with every level of the automation pyramid, e.g. field level, automation level, monitoring level and planning and analysis level.

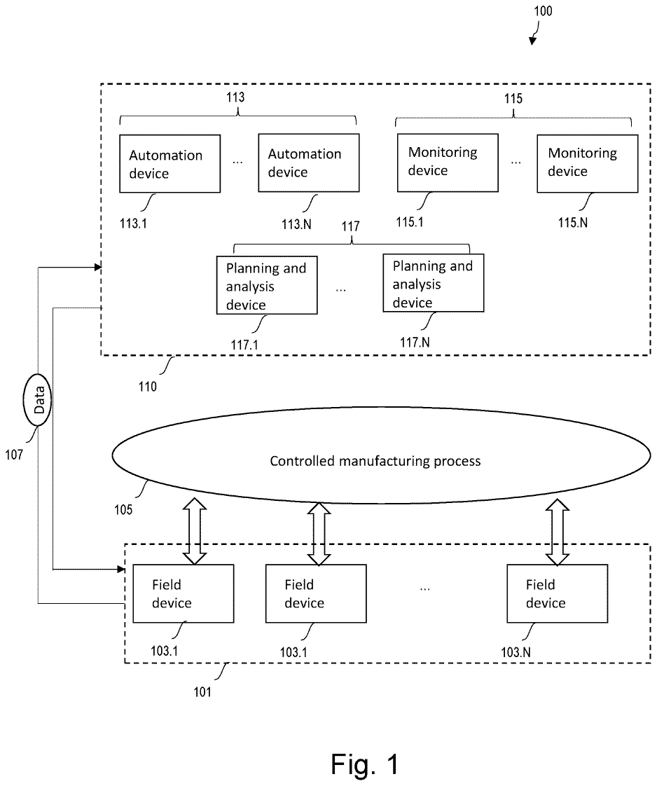

FIG. 1 depicts a distributed manufacturing automation system in accordance with an example of the present subject matter.

The distributed manufacturing automation system 100 comprises a manufacturing facility 101 having a number of field devices 103.1 through 103.N. The field devices 103.1-N may be provided with direct networking and computation capabilities. The field devices 103.1-N may include sensors, meters, motor drives, industrial robots, vision cameras, actuators or other such field devices. The field devices 103.1-N may be used to control one or more manufacturing processes 105. For that, the field devices 103.1-N may be configured to generate and/or collect process data relating to control of the manufacturing process 105. The field devices 103.1-N may be configured to transfer the process data 107 of the manufacturing process 105 to a data processing system 110 for analysis. For example, the manufacturing parameters of the manufacturing process 105 may be controlled through actuators based on the analysis.

The manufacturing process 105 may refer to the steps of a method used to prepare a composition in a manufacturing batch amount. A manufacturing process may, for example, include a joining process and/or shearing and forming process and/or molding process and/or machining process. The manufacturing process 105 may have one or more configurable manufacturing parameters such as mixing rate, temperature etc. Different types of control of the manufacturing process 105 may be used. Each type of control of the manufacturing process 105 may comprise an analysis step for analyzing of one or more manufacturing properties of the manufacturing process 105 and a control step for adjusting one or more manufacturing parameters of the manufacturing process 105 based on the analysis. The manufacturing property of the manufacturing process 105 may, for example, comprise duration, temperature, pressure, speed, quantity etc. The analysis step may comprise monitoring and/or processing of process data of the manufacturing process 105. The different types of control may differ, for example, in the type of the analysis performed and/or in the required time frame of the control e.g., one or more manufacturing parameters of the manufacturing process 105 may need to be controlled in real-time in order to meet required performance.

Each type of control of the manufacturing process 105 may require specific input data. The input data may comprise values of one or more manufacturing properties which may be obtained directly from the acquired process data 107 or be obtained after pre-processing the process data 107. In addition, each type of control of the manufacturing process 105 may have different processing resource requirement. Thus, in order to implement these different types of control of the manufacturing process 105, the data processing system 110 may be provided with different groups of devices 113, 115 and 117 each being associated with a respective type of control. Only three groups of devices are described, but it is not limited to.

The first group of devices 113 comprises automation devices 113.1-N. The automation devices 113.1-N may have a real-time capability. The automation devices 113.1-N may comprise Computer Numerical Control (CNC) machines, PLCs, etc. The automation devices 113.1-N may receive the process data 107 including manufacturing properties from various sensors and may drive actuators based on the processed sensor signals and control technique. The field devices 103.1-N together with the automation devices 113.1-N may form an automation system. Examples of automation systems may include a batch control system, continuous control system, or discrete control system.

The second group of devices 115 comprises monitoring devices 115.1-N. The monitoring devices 115.1-N may, for example, comprise Distribution Control System (DCS) devices or Supervisory Control and Data Acquisition (SCADA) devices. The monitoring devices 115.1-N facilitate intervening functions, supervising various manufacturing properties, setting production targets, historical archiving, setting machine start and shutdown, etc. The monitoring devices 115.1-N may persist, enrich/contextualize the process data 107 and made it available for consumption by other devices such as the analysis devices 117. The monitoring device 115.1-N may, for example, deploy a visualization application to enable plant operators to get insight into the persisted data and another application which implements a feedback mechanism into the devices of the first group 113 to autonomously react on certain events and adapt the manufacturing process according to generated insights.

The third group of devices 117 comprises planning and analysis devices 117.1-N. The planning and analysis devices 117.1-N may be configured to perform production planning, customer and market analysis, orders and sales, etc. The planning and analysis devices 117.1-N may, for example, be configured to carry out computationally expensive tasks like model training and validation. In another example, the planning and analysis devices 117.1-N may deploy applications that require highly available storage like long-term process data archives.

Each device of devices of the system 100 may be configured to exchange data with one or more devices of the same group to which it belongs and/or exchange data with one or more devices of the other group of devices in order to execute a task. For example, in order to perform a given type of control of the manufacturing process 105, a set of one or more of devices of the system 100 may be required. This set of devices may cooperate in order to execute the analysis step of the control using input data. The input data may be the (raw) process data 107 which is collected for the manufacturing process 105 or data obtained based on the process data 107 e.g., after pre-processing. The input data may be received at the set of devices from one or more devices of the system 100. Based on the result of the analysis, suggested adjustments of one or more manufacturing parameters of the manufacturing process may be provided by the set of devices. These adjustments may be applied by field devices such as actuators.

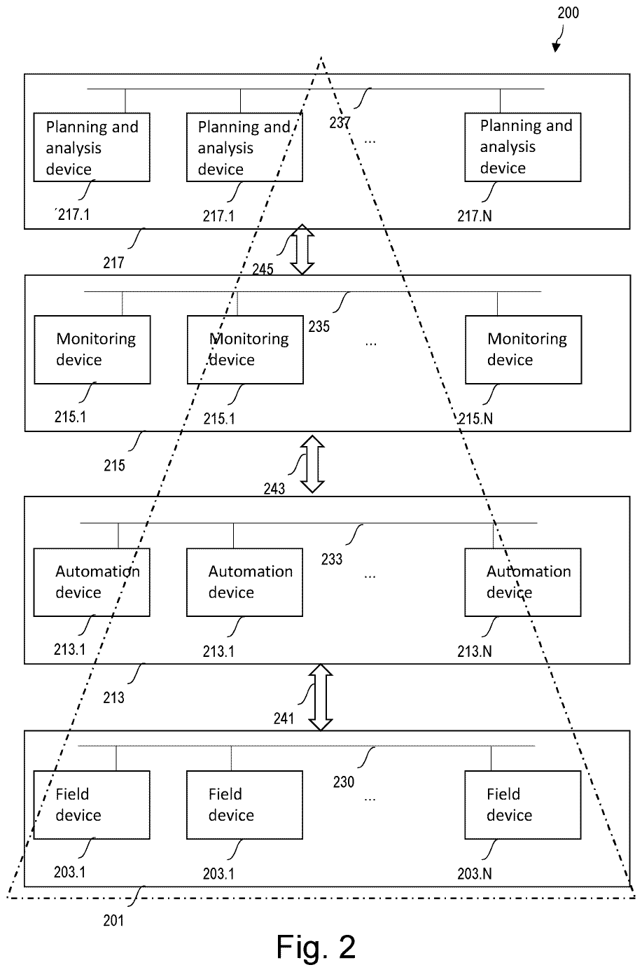

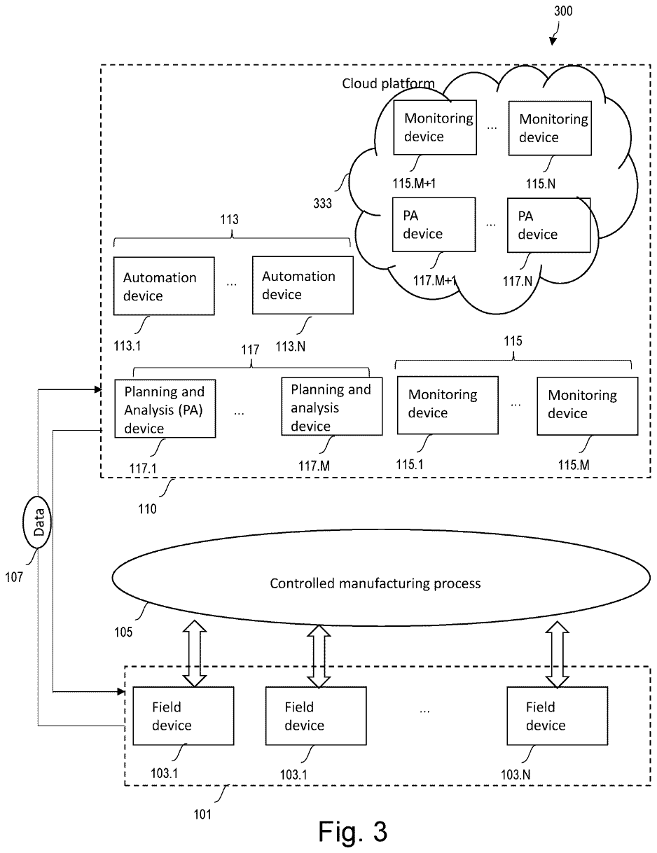

The different groups of devices may be integrated within the distributed manufacturing automation system 100 to provide continuous flow of information for the different types of control of the manufacturing process 105. The integration of the devices may be performed using different deployments and connection configurations. FIGS. 2 and 3 provide two example implementations, but it is not limited to.

FIG. 2 depicts a distributed manufacturing automation system in accordance with an example of the present subject matter.

As indicted in FIG. 2, the distributed manufacturing automation system 200 is configured according to a hierarchical pyramid model. The hierarchical pyramid model may be the ISA-95 pyramid model. With this configuration, the different groups of devices shown in FIG. 1 are connected over respective networks and the data is communicated between the manufacturing facility and the groups of devices following a predefined data flow using specific connections.

The distributed manufacturing automation system 200 is organized in different levels 201, 213, 215 and 217 of the hierarchical model. The first level 201 comprises field devices 203.1 through 203.N. The field devices 203.1-N may include sensors, meters, motor drives, industrial robots, vision cameras, actuators or other such field devices. The field devices 203.1-N may be used to monitor and/or control one or more manufacturing processes. The field devices 203.1-N may be configured to generate and/or collect process data relating to control of the manufacturing process. The field devices 203.1-N may be configured to transfer the data of the manufacturing process to the second level 213. The second level 213 comprises automation devices 213.1-N. The automation devices 213.1-N may comprise CNC machines, PLCs, etc. The automation devices 213.1-N may receive the data including manufacturing properties from various sensors and may drive actuators based on the processed sensor signals and program or control technique. The third level 215 comprises monitoring devices 215.1-N. The monitoring devices 215.1-N facilitates intervening functions, supervising various manufacturing properties, setting production targets, historical archiving, setting machine start and shutdown, etc. The monitoring devices 215.1-N may, for example, comprise DCS devices or SCADA devices. The fourth level 217 comprises planning and analysis devices 217.1-N. The planning and analysis devices 217.1-N may be configured to perform production planning, customer and market analysis, orders and sales, machine learning etc.

The devices within each level of the distributed manufacturing automation system 200 may be connected with each other over a respective network which is adapted to transmit data with the aid of a standard protocol. For example, the field devices 203.1-N may be connected with each other over a network 230. The automation devices 213.1-N may be connected with each other over a network 233. The monitoring devices 215.1-N may be connected with each other over a network 235. The planning and analysis devices 217.1-N may be connected with each other over a network 237.

The field devices 203.1-N may communicate with the automation devices 213.1-N via a connection 241. The connection 241 may be an analogue connection, field bus based connection or Ethernet based connection. The automation devices 213.1-N may communicate with the monitoring devices 215.1-N via a connection 243. The connection 243 may be an Ethernet based connection. The monitoring devices 215.1-N may communicate with the planning and analysis devices 217.1-N via a connection 245. The connection 245 may be an Ethernet based connection. Each of the connections 241, 243 and 245 may be provided with a firewall that controls the communication of the data through the respective connection.

The devices of the distributed manufacturing automation system 200 may cooperate according to this hierarchical model in order to perform different types of control of the manufacturing process. For example, using the system 200, an operating division of a chemical company may monitor its production quality and actively react to product quality issues by automatically generating feedback to the automation system.

FIG. 3 depicts a distributed manufacturing automation system in accordance with an example of the present subject matter.

The distributed manufacturing automation system 300 provides an example implementation of the data processing system 110 of the system of FIG. 1. At least part of the second and third groups of devices may be implemented in a cloud platform 333 to leverage cloud-based applications and services. The cloud platform 333 may, for example, be provided by a cloud provider as a platform-as-a-service (PaaS). For example, a subgroup 115.1 to 115.M of the second group of devices 115 may be implemented as a local data center and the remaining subgroup 115.M+1 to 115.N may be implemented in the cloud platform 333. Alternatively of additionally, a subgroup 117.1 to 117.M of the third group of devices 115 may be implemented as a local data center and the remaining subgroup 117.M+1 to 117.N may be implemented in the cloud platform 333. The devices in the cloud platform 333 may be configured to communicate through the internet in order to exchange data with other devices of the data processing system 110. The devices of the local data centers as well as the devices of the cloud platform may cooperate in order to perform different types of control of the manufacturing process.

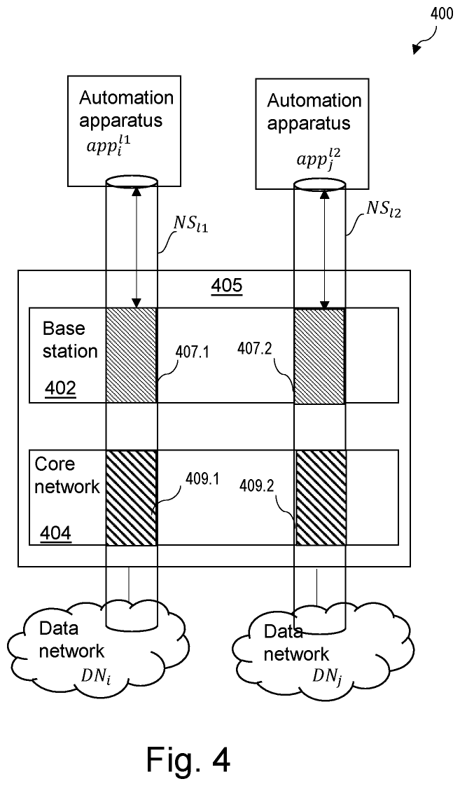

FIG. 4 depicts a system for enabling communication of data at a distributed manufacturing automation system according to an example of the present subject matter.

The wireless communication system 400 includes a cellular network 405. The cellular network 405 includes a base station 402 which communicates over transmission mediums with automation apparatuses

$${app}_{i}^{l 1} and {app}_{j}^{l 2} .$$

The automation apparatuses

$${app}_{i}^{l 1} and {app}_{j}^{l 2}$$

may be part of the distributed manufacturing automation system. The automation apparatus

$${app}_{i}^{l 1}$$

may belong to level l1 of the automation pyramid and the automation apparatus

$${app}_{j}^{l 2}$$

may belong to level l2 of the automation pyramid. l1 may be any number between 1 and the total number K of levels of the automation pyramid. l2 may be any number between 1 and the total number K of levels of the automation pyramid where l2 is different from l1. Each of the automation apparatus

$${app}_{i}^{l 1} and {app}_{j}^{l 2}$$

may be any device of the field devices, automation devices, monitoring devices and planning and analysis devices as described with reference to FIG. 1, FIG. 2 and FIG. 3.

The base station 402 may be base transceiver stations (BTS) and may include hardware that enables wireless communication with the automation apparatuses

$${app}_{i}^{l 1} and {app}_{j}^{l 2} .$$

The base station 402 may be coupled to core network 404. The core network 404 may also be coupled to one or more data networks such as data networks DNᵢ and DNⱼ. Each of data networks DNᵢ and DNⱼ may be a network of the distributed manufacturing automation system or an external network. The external network may include the Internet, a Public Switched Telephone Network (PSTN), and/or any other network. Thus, the base station 402 may facilitate communication between the automation apparatuses

$${app}_{i}^{l 1} and {app}_{j}^{l 2}$$

and the networks 404, DNᵢ and DNⱼ.

The base station 402 and the automation apparatuses

$${app}_{i}^{l 1} and {app}_{j}^{l 2}$$

may be configured to communicate over the transmission medium using various radio access technologies (RATs), such as long-term evolution (LTE) and 5G new radio (5G NR) etc.

The automation apparatuses

$${app}_{i}^{l 1} and {app}_{j}^{l 2}$$

may be configured to communicate with data networks DN, and DNᵢ using slice networks NSₗ₁ and NSₗ₂ respectively. The network slices NSₗ₁ and NSₗ₂ are assigned exclusively to the levels l1 and l2 respectively, meaning that only apparatuses of the level l1 may use the network slice NSₗ₁ and only apparatuses of the level l2 may use the network slice NSₗ₂.

The network slice NSₗ₁ may be defined using at least two segments. The first segment 407.1 at the base station level may be an access slice that supports different radio or fixed access at the base station. The second segment 409.1 at the core network level may be a core network slice which provides one or multiple virtualized network functions. An additional segment may, for example, be a slice pairing function that connects the first segment 407.1 and second segment 409.1 to form an end-to-end network slice NSₗ₁. Similarly, the network slice NSₗ₂ may be defined using at least two segments. The network slice NSₗ₂ may comprise a first segment 407.2 at the base station 402 and a second segment 409.2 at the core network 404.

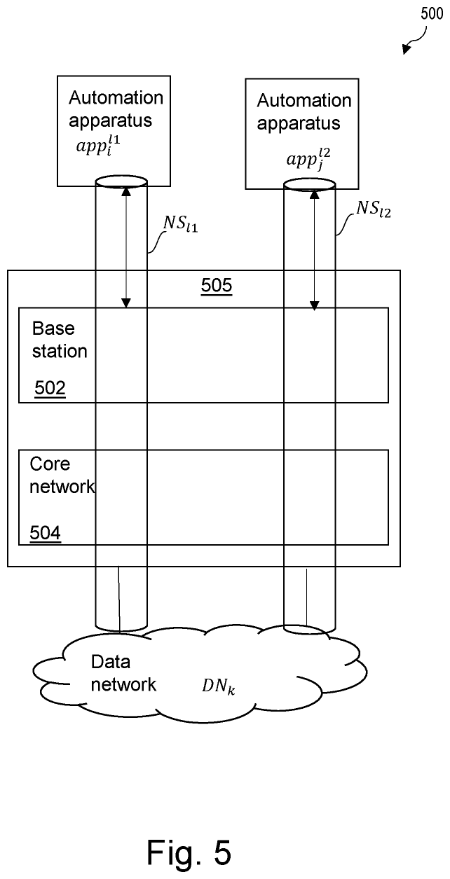

FIG. 5 depicts a system for enabling communication of data at a distributed manufacturing automation system according to an example of the present subject matter.

The wireless communication system 500 includes a cellular network 505. The cellular network 505 includes a base station 502 which communicates over transmission mediums with automation apparatuses

$${app}_{i}^{l 1} and {app}_{j}^{l 2} .$$

The automation apparatuses

$${app}_{i}^{l 1} and {app}_{j}^{l 2}$$

may be part of the distributed manufacturing automation system. The automation apparatus

$${app}_{i}^{l 1}$$

may belong to level l1 of the automation pyramid and the automation apparatus

$${app}_{j}^{l 2}$$

may belong to level l2 of the automation pyramid. l1 may be any number between 1 and the total number K of levels of the automation pyramid. l2 may be any number between 1 and the total number K of levels of the automation pyramid, where l2 is different from l1. Each of the automation apparatuses

$${app}_{i}^{l 1} and {app}_{j}^{l 2}$$

may be any device of the field devices, automation devices, monitoring devices and planning and analysis devices as described with reference to FIG. 1, FIG. 2 and FIG. 3.

The base station 502 may be base transceiver stations (BTS) and may include hardware that enables wireless communication with the automation apparatuses

$${app}_{i}^{l 1} and {app}_{j}^{l 2} .$$

The base station 502 may be coupled to core network 504. The core network 504 may also be coupled to a data network such as data network DNₖ. The data network DNₖ may be a network of the distributed manufacturing automation system or an external network. The external network may include the Internet, a Public Switched Telephone Network (PSTN), and/or any other network. Thus, the base station 502 may facilitate communication between the automation apparatuses

$${app}_{i}^{l 1} and {app}_{j}^{l 2}$$

and the networks 504 and DNₖ.

The base station 502 and the automation apparatuses

$${app}_{i}^{l 1} and {app}_{j}^{l 2}$$

may be configured to communicate over the transmission medium using various radio access technologies (RATs), such as long-term evolution (LTE) and 5G new radio (5G NR) etc.

The automation apparatuses

$${app}_{i}^{l 1} and {app}_{j}^{l 2}$$

may be configured to communicate with the same data network DNₖ using distinct slice networks NSₗ₁ and NSₗ₂ respectively as they belong to two different levels l1 and l2. The slice networks NSₗ₁ and NSₗ₂ are assigned exclusively to the levels l1 and l2 respectively, meaning that only apparatuses of the level l1 may use the network slice NSₗ₁ and only apparatuses of the level l2 may use the network slice NSₗ₂.

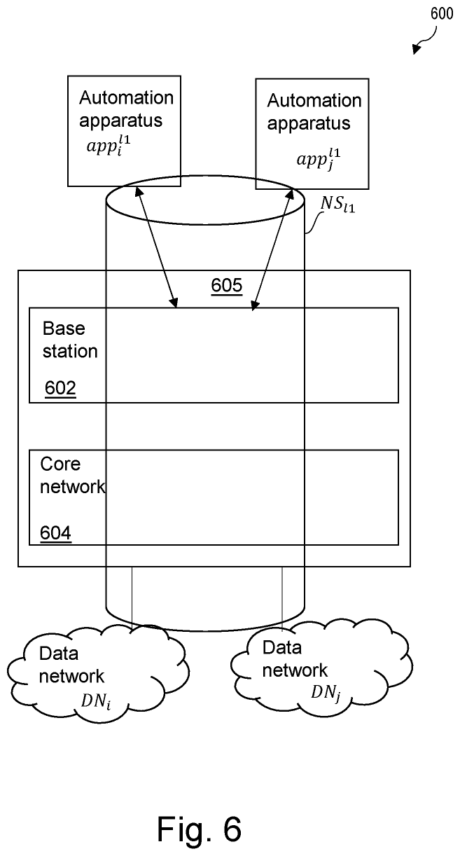

FIG. 6 depicts a system for enabling communication of data at a distributed manufacturing automation system according to an example of the present subject matter.

The wireless communication system 600 includes a cellular network 605. The cellular network 605 includes a base station 602 which communicates over transmission mediums with automation apparatuses

$${app}_{i}^{l 1} and {app}_{j}^{l 1}$$

The automation apparatuses

$${app}_{i}^{l 1} and {app}_{j}^{l 1}$$

may be part of the distributed manufacturing automation system. The automation apparatuses

$${app}_{i}^{l 1} and {app}_{j}^{l 1}$$

may belong to the same level l1 of the automation pyramid. l1 may be any number between 1 and the total number K of levels of the automation pyramid. Each of the automation apparatuses

$${app}_{i}^{l 1} and {app}_{j}^{l 1}$$

may be any device of the field devices, automation devices, monitoring devices and planning and analysis devices as described with reference to FIG. 1, FIG. 2 and FIG. 3.

The base station 602 may be base transceiver stations (BTS) and may include hardware that enables wireless communication with the automation apparatuses

$${app}_{i}^{l 1} and {app}_{j}^{l 1}$$

The base station 602 may be coupled to core network 604. The core network 604 may also be coupled to one or more data networks such as data networks DNᵢ and DNⱼ. Each of data networks DNᵢ and DNⱼ may be a network of the distributed manufacturing automation system or an external network. The external network may include the Internet, a Public Switched Telephone Network (PSTN), and/or any other network. Thus, the base station 602 may facilitate communication between the automation apparatuses

$${app}_{i}^{l 1} and {app}_{j}^{l 1}$$

and the networks 604, DNᵢ and DNⱼ.

The base station 602 and the automation apparatuses

$${app}_{i}^{l 1} and {app}_{j}^{l 1}$$

may be configured to communicate over the transmission medium using various radio access technologies (RATs), such as long-term evolution (LTE) and 5G new radio (5G NR) etc.

The automation apparatuses

$${app}_{i}^{l 1} and {app}_{j}^{l 1}$$

may be configured to communicate with data networks DN and DNⱼ using the same slice network NSₗ₁ which is assigned exclusively to the level l1, meaning that only apparatuses of the level l1 may use the network slice NSₗ₁.

FIG. 6a depicts a scheduling device 610 for a system for enabling communication of data at a distributed manufacturing automation system according to an example of the present subject matter.

The scheduling device 610 and/or balancing device 610 is shown as a separate device between the different automation apparatuses appl and the cellular network 605. However, it may also comprise the automation apparatuses appl and/or the cellular network 605. The scheduling device 610 may be realised as an edge device and/or concentrator to collect the traffic of a location on a site, e.g. the traffic from a plant.

In one example, the lower the level in the hierarchical pyramid model as shown in FIG. 2 the closer the level to raw data. Raw data may be provided as substantially analogue data and/or bus data. Raw data may also be provided as digital data in a bus protocol format after processing the analogue data. In an example, the higher the level of the hierarchy the more packaging data may be included in the exchanged data. For example, each hierarchical layer adds a header for the specific layer to the data. In case that the hierarchy is arranged according to the OSI network model, each layer adds its own PDU (Protocol data unit). The one and/or plurality of interface(s) of the automation apparatus may be adapted to unpack and/or pack data according to the connected network hierarchy. The PDU may embed the payload data which substantially are the data of the lowest hierarchical level, e.g. the field device data.

In another example the level of the hierarchical pyramid model may be indicated by a level indicator, level identifier and/or level ID. The level indicator may be added to a da-ta package distributed in a network in order to show the association with a predefined level. Devices belonging to a specific level may be grouped together by using the same level indicator. The differentiation between participants of a functional level may be realised by employing sub-network masks used for filtering predefined functional groups of devices and their members. A sub-network mask may be a bit pattern that allow for filtering data packets and/or data streams by XOR operations. The level identifier may be a bit pattern where the set bit represents the level in the pyramid. For example, in a 5 bit header the bit pattern 00001 represents level 1, 00010 represents level 2 etc. In other words, the length of the level identifier corresponds to the number of avail-able levels and the position where a bit is set in the header corresponds to the level to which a data packet is associated with.

The scheduling device 610 with the automation apparatuses appl may have a level identifier allocation device which receives input from a specific network 230, 233, 235, 237 of a level and adds the respective bit pattern to traffic from that respective network. The bit pattern may be used for an internal routing process in-side the automation apparatus. In an example the scheduling device 610 may have different ports for connecting the different networks corresponding to a specific level. E.g. Port 1 is allocated to field device network, level 1, port 2 is allocated to automation de-vice network, level 2 etc. The automation apparatuses appl may be part of such a port to connect a relevant level of network 230, 233, 235, 237.

In another example, each level may form a separate network, e.g. a VLAN (virtual local area network). In such an example, devices belonging to the same level may be indicated as belonging to the same network. In an example the differentiation between different devices may be made by registering an address, e.g. IP address, MAC address in a network dedicated to a specific level.

A combination of the different level indicators and level allocations may be possible.

The level of a functional model may be mapped to a quality parameter for a network and to specific network parameter of the backbone network. One quality parameter may be latency, another parameter may be reliability.

In an example a manufacturing device, e.g. a sensor, may request a predefined latency for data transmission. Such a request may be made by the sending of a request package from the manufacturing device to the scheduling device 610 and/or to the specific automation apparatus

$${app}_{i}^{l} .$$

The scheduling device 610 may be adapted to verify whether the requested predefined quality may be met by the backbone network in order to guarantee the same high latency that is required for a certain level of devices of a functional level of the functional model.

Thus, the scheduling device 610 also have an overview of the characteristics of the different slices NSₗ. It may map a certain traffic profile to the corresponding slice.

Sensor data and/or field device data may be analogue data. After pre-processing, e.g. by A/D converters the sensors may also provide digital data. The scheduling device 610 may comprise such an A/D converter for a direct sensor connection.

The scheduling device 610 may be adapted for scheduling data according to predefined criteria. E.g. it may be possible that different grades of latency exist for different levels. However, it may happen that a bulk of data arrive having low latency requirements. However, the quantity of arriving data is such high that they may not be handled from the connection and/or slice with the appropriate latency level. Then a slices NSₗ may be used of a higher latency level, if such connection may at the moment of data arriving is available and/or unused. For example, field device data may be allocated to a high latency requirement. Planning data may be allocated to a low latency requirement. However, e.g. a backup is made and high data traffic suddenly appears. If at the same time the activity of the high latency level, e.g. field devices, is low, this free capacity may be used for the traffic with the lower priority. In this case the scheduling device 610 may distribute the traffic, e.g. a data item, to the different channels, in particular to the relevant cellular networks. The scheduling may allow for an effective use of the available frequency bands. An operator in the industrial field may do not have to pay extra fees for additional bandwidth within the predefined frequency band. Thus, an optimum use of the leased frequency bands may be made.

The scheduling device 610 may be adapted to detect the profile of the different apparatuses of the groups of apparatuses and knows about the characteristics of the different network slices. Thus, the scheduling device 610 may be adapted to allocate the profile to the appropriate slice.

However, one of the apparatuses may generate two or more types and/or profiles of traffic. When the scheduling device 610 recognizes that the different profiles of traffic may need to be allocated to different slices, the scheduling device 610 may be adapted to extract a sub-data item and/or the different profile traffic and use a second network slice and/or a third network slice different from the first network slice for that different profile and/or sub-data item.

In a campus network it may also be possible to have a dynamically controlled latency or any other characteristic dependent on a certain location. In a company site temporarily, some additional locations may be needed to be supplied with communication capacities. E.g. temporarily some measurements may need to be taken in a specific plant by using special measurement equipment. In such cases it may be possible that this special measurement equipment may have a high requirement for latency for transmitting the data. Having a scheduling device 610, that may be adapted to set up temporarily and/or dynamically the latency levels, may increase the flexibility for a mobile network. This feature may be referred to as location-based latency and/or more general as location-based slicing as it may be possible for any characteristic and/or combination of characteristics of slices to dynamically extract some traffic and put it to the appropriate slice.

In an example the scheduling device 610 may comprise a location detection device, e.g. a GPS receiver. As soon as the automation apparatus detects a certain location of a campus, e.g. detects the proximity to a plant where sensors with high latency requirements are used, the latency level may be adapted automatically and the data item is sent to each of the different slices of the cellular network according to the latency level.

In one example the latency may correspond to the number of levels of the hierarchical pyramid model. For example, the hierarchical pyramid model may have 4 levels, where data from the field device level may use a fourth of the latency of level 4, the data from the third level have a third of the latency of level 4 etc. The scheduling device 610 may have a latency exploring device which may request a field device, automation device, monitoring device and/or planning and analysis device for its desired latency level.

The destination for the transmitted processing data and/or data item may be a receiver on a remote location. The receiver may be a server, a data network and/or a further part of a VPN (virtual private network).

The different networks 230, 233, 235, 237 of FIG. 2 may extend over different locations. In such a case the slicing as of FIG. 6a may be made between the different networks. In other words, each network 230, 233, 235, 237 may be connected to a different slice. However, if for example a field device may generate different profiles of traffic, some traffic may be allocated to the in-appropriate network slice. If for example a field device usually generates latency sensitive traffic it may be routed to a slice of low latency. If traffic appears that has low latency requirements it may be also transmitted over the slice with low latency, which may be of high cost. Thus, extracting this traffic and divert it over a slice with high latency may reduce the technical effort and may free bandwidth for other latency sensitive traffic.

It may also be possible that a device allocated to the group of apparatuses of high latency requirements may be detected by monitoring as not having high latency requirements. Traffic of such a device may be diverted to a different slice as to the slice according to the level of the functional model.

For example, a camera that generates a constant picture may not have high requirements to latency. Then it may be shifted to a different layer of the functional model, different as the level it would be classified by its device type. Thus, it may be possible to at least temporarily schedule an apparatus according to the current traffic profile and not to the device type and therefore, the scheduling device 610 may schedule the slice to a current traffic profile, to a temporarily profile and/or to a location-based traffic profile.

FIG. 7 is a flowchart of a method for a distributed manufacturing automation system being configured such as an automation pyramid.

Network slices NSₗ, where l varies between 1 and K, the number of levels of automation pyramid, may be created and assigned in step 701 to respective levels of the automation pyramid.

An automation apparatus

$${app}_{i}^{l} .$$

of a specific level l of the automation pyramid may use in step 703 the network slice NSₗ assigned to that level for an end-to-end connection with a data network.

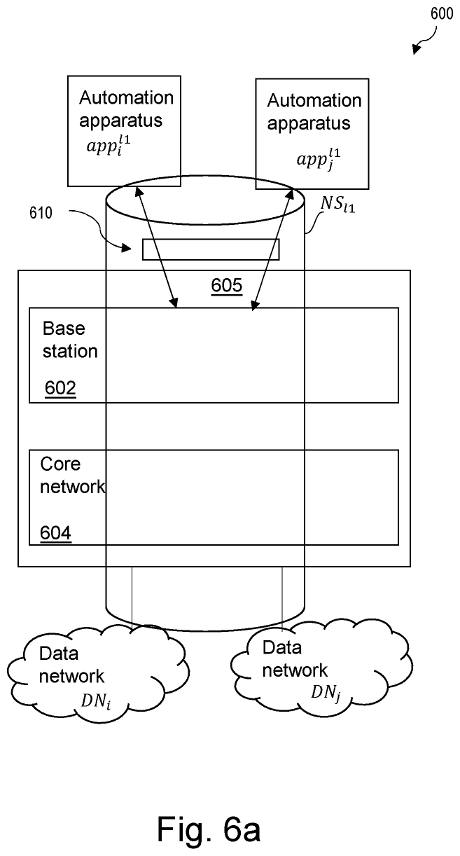

FIG. 8 is a flowchart of a method for a distributed manufacturing automation system comprising multiple groups of apparatuses such as the groups 113, 115 and 117 shown with reference to FIG. 1. Each group of apparatuses of the groups of apparatuses is configured to perform a respective type of control of a manufacturing process.

Network slices may be created and assigned in step 711 to respective groups of the distributed manufacturing automation system. Each group of the groups may be assigned a distinct network slice.

An automation apparatus of a group of the groups may use in step 713 the network slice assigned to that group for an end-to-end connection with a data network.

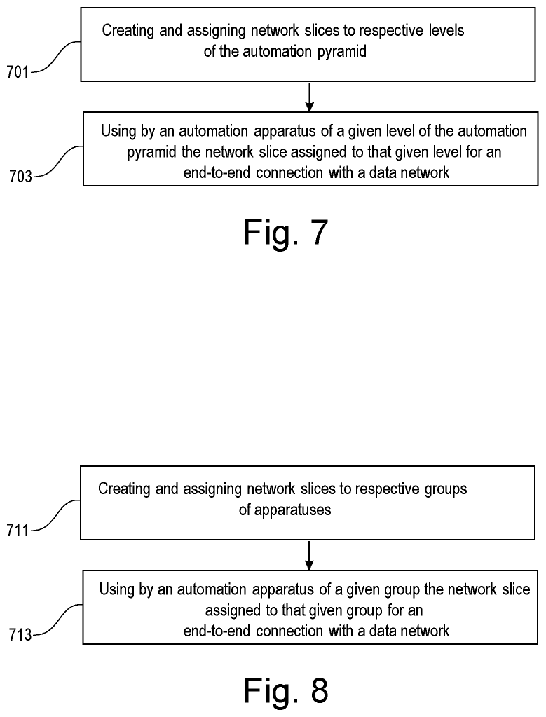

FIG. 9 depicts a system for enabling communication of data at a distributed manufacturing automation system according to an example of the present subject matter.

The wireless communication system 800 includes a 5G cellular network 805. The cellular network 805 includes an access node (AN) 802 which communicates over transmission mediums with an automation apparatus 801. The automation apparatus 801 may be part of the distributed manufacturing automation system. The automation apparatus 801 may be any device of the field devices, automation devices, monitoring devices and planning and analysis devices as described with reference to FIG. 1, FIG. 2 and FIG. 3. The access node 802 may be coupled to a 5G core network 804. The core network 804 may also be coupled to IT network and OT network of the distributed manufacturing automation system. The core network 804 may enable AMF functionality 809 and SMF functionality 810. The core network 804 may enable a UPF 811 for uplink classification and two UPFs, UPF1 and UPF2, as PDU session anchors.

The automation apparatus 801 may set up a first PDU session via AN 802 to the UPF1 for establishing an end-to-end connection to the IT network. Alternatively, the automation apparatus 801 may set up a second PDU session via AN 802 to the UPF2 for establishing an end-to-end connection to the OT network.

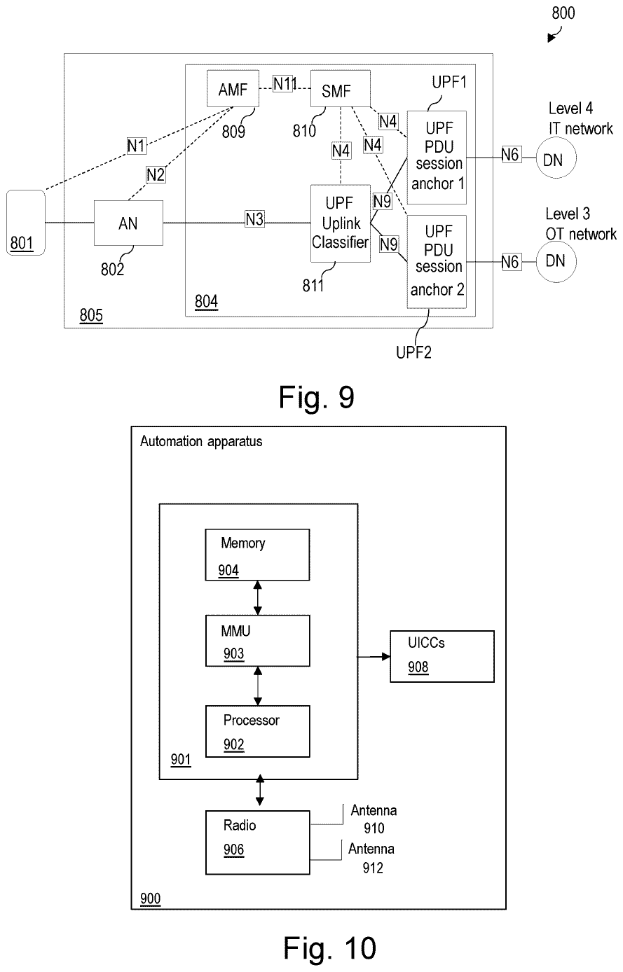

FIG. 10 depicts an example simplified block diagram of an automation apparatus according to an example of the present subject matter.

The automation apparatus 900 may comprise a System-on-a-Chip (SOC) 901 including processor(s) 902, which may execute program instructions for the automation apparatus 900. The processor(s) 902 may be coupled to memory management unit (MMU) 903 of the SOC 901, which may be configured to receive addresses from the processor(s) 902 and translate those addresses to locations in a memory 904 of the SOC 901 and/or to other circuits or devices, such as cellular communication circuitry. The automation apparatus 900 may further include a cellular communication circuitry 906 such as for 5G, LTE, etc. The automation apparatus 901 may further comprise two or more smart cards 908 that each comprises SIM functionality, such as two or more Universal Integrated Circuit Cards (UICCs) 908. The cellular communication circuitry 906 may couple to one or more antennas, preferably two antennas 910 and 912. It is to be noted that the automation apparatus 900 shown in FIG. 9 may comprise several further elements or functions besides those described herein below, which are omitted herein for the sake of simplicity as they are not essential for the understanding.

The inclusion of two or more SIM cards 908 may allow the automation apparatus to support two different identifiers and may allow the automation apparatus 900 to communicate on corresponding two or more respective networks. The cellular communication circuitry 906 may comprise two distinct radios, each having a receive chain and a transmit chain. The two radios may support separate RAT stacks.

The processor 902 is configured to execute processing related to the above described subject matter. For example, the processor 902 may be configured to execute the method of FIG. 7 or FIG. 8.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. ‘Computer memory’ or ‘memory’ is an example of a computer-readable storage medium.

Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances, the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1. A distributed manufacturing automation system comprising multiple groups of apparatuses, wherein each group of apparatuses of the groups of apparatuses is configured to perform a respective type of control of a manufacturing process, the distributed manufacturing automation system comprising a first apparatus of a specific group of apparatuses of the multiple groups, the first apparatus comprising means being configured to use a first network slice for an end-to-end connection with a data network, the first network slice being assigned to the specific group of apparatuses; and
wherein the means of the first apparatus of the group of apparatuses are further configured to generate a data item and to extract a sub-data item from the data item and to use a second network slice and/or a third network slice different from the first network slice for the extracted sub-data item.

2. The distributed manufacturing automation system of claim 1,
wherein the means of the first apparatus of the group of apparatuses are further configured to determine which of the second network slice and/or the third network slice is appropriate to be used.

3. The distributed manufacturing automation system of claim 2, wherein the determining of which of the second network slice and/or the third network slice is appropriate to be used is based on a monitoring operation.

4. The distributed manufacturing automation system of claim 3, wherein the monitoring operation comprises machine learning.

5. The distributed manufacturing automation system of claim 1, being configured as an automation pyramid, wherein each group of the multiple groups belongs to a distinct level of the automation pyramid.

6. The distributed manufacturing automation system of claim 1, comprising a second apparatus of another group of the groups, the second apparatus comprising means being configured to use a second network slice for an end-to-end connection with a data network, the second network slice being exclusively assigned to the other group.

7. The distributed manufacturing automation system of claim 5, the data network of the first network slice being a network at the level of the first apparatus or at another level of the automation pyramid, the data network of the second network slice being a network at the level of the second apparatus of or at another level of the automation pyramid.

8. The distributed manufacturing automation system of claim 1, further comprising a cellular network comprising a base station and a core network device, wherein the first network slice, the second network slice and/or the further network slice comprising a first user plane function network element, a second user plane function network element and a further user plane function of the core network device respectively.

9. The distributed manufacturing automation system of claim 1, the data network being an information technology network and/or an operation technology network of the distributed manufacturing automation system.

10. The distributed manufacturing automation system of claim 1, wherein each slice of the network slices being configured according to a predefined latency value, to a throughput value and/or to a specific security level.

11. The distributed manufacturing automation system of claim 10, wherein a data communication through the slice is secured according to the specific security level using at least one of: authentication, encryption and slice isolation with exclusive network resources.

12. The distributed manufacturing automation system of claim 1, each slice of the network slices being configured according to a distinct value of a performance parameter, the performance parameter comprising at least one of: availability, area of service, isolation level, maximum packet size, maximum number of apparatuses that can use the network slice simultaneously, and radio spectrum in which the network slice is supported.

13. A method for a distributed manufacturing automation system comprising multiple groups of apparatuses, wherein each group of apparatuses of the groups of apparatuses is configured to perform a respective type of control of a manufacturing process, the method comprising using by a first apparatus of a specific group of the groups a first network slice for an end-to-end connection with a data network, wherein the first network slice is assigned to the specific group,
wherein the method comprises generating a data item and to extract a sub-data item from the data item and to use a second network slice and/or a third network slice different from the first network slice for the extracted sub-data item.

14. A computer program product comprising a computer-readable storage medium having computer-readable program code embodied therewith, the computer-readable program code configured to implement the method of claim 13.

15. An apparatus for a specific group of apparatuses of a distributed manufacturing automation system, the apparatus comprising means being configured to use a first network slice for an end-to-end connection with a data network, the first network slice being exclusively assigned to the specific group.
